(19) United States
(12) Patent Application Publication
(10) Pub. No.: US 2006/0201417 A1
(43) Pub. Date: Sep. 14, 2006

(54) Dispenser cabinet

(76) Inventor: Marc Radow, Reno, NV (US)

Correspondence Address: MARC RADOW, 1900 Joy Lake Road, Reno, NV, 89511, US

(21) Appl. No.: 11/077,559

(22) Filed: Mar. 9, 2005

(51) Int. Cl. B05D 1/18; B05B 13/06

(52) U.S. Cl. 118/306; 427/430.1; 118/317

(57) ABSTRACT

A method and a device for preparing drinkware where a substance is applied to the rim of the drink-ware and substances can be dispensed from the device. One device includes a cabinet that can house and dispense substances, and the substances may either be filled directly into receptacles, stands, arms or drawers and/or pre-filled in contoured drawer liners. The cabinet may include a moistening reservoir and separates the moistening reservoir from the Spice by housing the moistening agent in a distinct and separate location.

### BACKGROUND OF THE INVENTION

This invention relates to a novel method and a novel device for applying a dry granular, flaked, shaved or powder substance (Spice) to the rim of drink-ware, when two (2) or more Spice options are desired to select from. And said device provides for easy access to said Spices, economizes available bar space and protects and preserves the components of the drinkware rimming system (Spices, wetting agent and suspension material) in the preparation of rimming a beverage of any type, nature, alcoholic or otherwise.

Rimming drinkware for beverages unto itself is not novel. The margarita, a cocktail which is generally made with tequila liquor mixed with lime, lemon and other juices and cordials had been served in drinkware whose rims were coated with salt. This salted rim application had customarily been accomplished by moistening the rim of the glass with an aqueous solution and inserting the moistened rim into a dish or reservoir of salt.

Rimming drinkware however has grown in popularity as on-premise establishments (e.g. restaurant, nightclub, clubhouse, café, bar, tavern, etc.) strive to improve consumer perception of drink values, reduce costs and/or offer presentations where consumers otherwise may not readily have access to. Traditional salt as described in the above Margarita example, and similarly ordinary sugar, have fallen short of consumer and vendor expectations. Spice, however, with its brilliant colors, array of flavors and powerful aromas that include expensive food science ingredients and preparations have captured both consumer and vendor imagination. As a result the number and complexity of different Spice preparations have exploded.

Current rimming devices ‘rimmers’ were designed for salt and sugar as explained above. Both salt and sugar have no added ingredients and are relatively inexpensive commodities. There had been little or no cause for handling with increased or specialized care, protecting or preserving them. For example, when cleaning the devices, excess salt or sugar could easily be discarded.

Rimmers also are designed to accommodate at most two (2) ‘Spice’ selections (e.g. salt and sugar) and, if so equipped, inadequately separate a moistening agent and/or suspension material such as a sponge away from the Spice to avoid cross contamination.

Spice formulations today include expensive flavors, colors and food ingredients for specific performance criteria. The preparations can be expensive, particularly in contrast to ounce/ounce comparisons to both salt and sugar commodities and vendors are reluctant to simply discard unused quantities. It is undesirable for one Spice preparation to interfere, blend or mix with any other Spice(s) and particularly adverse for the moistening agent to contaminate any of the Spices due to evaporation, spilling or other possible mishap.

The present invention addresses and solves the logistic, ergonomic and economic considerations presented. The present invention houses two (2) or more Spice selections, separates and protects one Spice from all others, easily allows users to remove one spice from the cabinet for cleaning/exchanging/replenishing purposes, separates and protects all spices from the wetting agent and its reservoir and/or Rimming Dish and consumes less area than traditional rimmers in overall footprint and particularly on a per spice to area ratio.

New beverage options enter the marketplace every day and continue to crowd bars and beverage preparation areas. As a result, vendors are seeking to economize every aspect of space, use every ounce of product and to maximize productivity while offering exciting and diverse preparations. Traditional rimmers would force vendors to attempt to use many individual dispensers or use many traditional rimmers, but all of such alternatives are undesirable in terms of their functionality, ergonomics, preservation of the spice and space utilization. The concept of rimming beverages has suffered as a result of these inadequacies. The Rimming Cabinet as described herein resolves the presented obstacles.

### BRIEF SUMMARY OF THE INVENTION

The present invention is directed to a novel device and method of applying a dry granular, flaked, shaved or powder substance (Spice) to the rim of common drinkware and to afford access to two (2) or more Spice selections for use in a preferred embodiment of that method.

In accordance with the method of this invention, a wetting agent is applied to the rim of drinkware to moisten its rim. The drinkware, again inverted, is introduced into customarily one (or more) said Spice selections, which thus adheres to the rim of the drinkware by virtue of the kinematic forces present in the moisture on the moistened rim.

A principal object of this invention is to provide a novel and improved method and device of dispensing or otherwise making easily available two (2) or more Spice selections from the same device in preparing a beverage whose rim is coated with a Spice and similarly to apply the wetting agent by means of the same device.

Two or more Spice dispensing locations by means of Drawers, arms, stands or otherwise (Drawers) are shaped and contoured so that the Spice when introduced into the Drawer, due to the force of gravity, naturally draws the spice to the outer edges of the interior contour of the Drawer. This distribution effect shall cause the Spice to be more efficiently utilized, increasing yield per ounce of Spice and reducing potential waste of remaining Spice in the Drawer and further when drinkware is inverted and introduced into the drawer, the Spice may more completely extend over the drinkware rim.

A contoured Liner may be inserted and fitted into the Drawer thereby protecting and separating the Drawer from the Spice and better facilitate exchanging a Spice in a particular Drawer and cleaning a Spice from a Drawer. Further, a Liner may be required to house the Spice into a fitted, contoured AND a hollowed Drawer. In either Drawer scenario e.g. hollowed or contoured/fitted, said Liner may be pre-filled, re-filled, removed, discarded, cleaned and/or readily exchanged with the same or different Spice in any one or other Drawers.

Similarly, the Liner may also be contoured so Spice will migrate naturally due to the forces of gravity toward the interior outer edges of the Liner due to gravity's presence on Spice in the Liner and Spice will migrate away from the center point of the Liner, down its descents and toward the outer and interior edge of the Liner's plane. This process affords greater contact area over drinkware rim and the Spice. The process will further afford greater utilization of Spice (e.g. less waste) in the liner and/or drawer.

The device shall also provide for a wetting reservoir and area for the customary practice of applying a wetting agent to the rim of the drinkware when it is inverted and its rim introduced into the wetting agent. This wetting reservoir may similarly be contoured (female) to accommodate a liner styled apparatus or Rimming Dish (male). In either scenario, the wetting reservoir or the Rimming Dish would house and serve to apply the wetting agent, and if so desired include a suspension material such as a sponge, to apply the wetting agent to the rim of the drinkware when it is inverted and introduced into the wetting agent and/or suspension material.

That the wetting reservoir and Rimming Dish is of greater depth and height than that of the suspension material so as to reduce the potential for spilling or overflow of the wetting agent when the wetting agent is applied into the wetting reservoir and/or onto the suspension material. And further to reduce the potential for overflow of the wetting agent over the wetting reservoir and/or Rimming Dish when drinkware is introduced into the wetting reservoir, Rimming Dish or suspension material causing a reduction in capacity for the wetting agent in the wetting reservoir and Rimming Dish.

Said Rimming Dish shall be contoured with thumb and finger grasp center post and peripheral edge so that either location(s) may serve as handling points. These handling points will facilitate removal, replacement to refill, replace, discard, clean and/or readily exchange with new said Rimming Dish, wetting agent and or suspension material.

Further objects and advantages of this invention will be apparent from the following detailed description of presently preferred embodiments with reference to the accompanying drawings.

### BRIEF DESCRIPTION OF THE DRAWINGS

FIG. 1 is a sectional view of the Rimming Cabinet showing its internal aspects, including drawers, drawer liner option and drawer separators (that which distinguishes and separates one Spice location and housing from all other Spice selections including the wetting agent). It also depicts the rim wetting reservoir, Rimming Dish option and one drawer extended to expose the SPICE in accordance with one or more novel aspects of the present invention for use in practicing the methods described in this invention.

The extension of the base (e.g. footprint) that accommodates the wetting reservoir and/or Rimming Dish is extended in the direction of the Drawer opening and creates a lever point at the furthest point in the front of the base of the Cabinet (in the direction of the drawer extension), so that when a Drawer is opened, particularly one that is filled with Spice and particularly when drinkware is depressed into the Spice, the resulting weight and downward forces could otherwise topple the Cabinet forward in the direction of the extended drawer and make the structure less sturdy. The extension of the base affords stability when a Drawer is extended and when drinkware is depressed into a Drawer & Spice.

The bottom surface area of the base at where the Cabinet makes contact with that of any countertop, table top or other surface the Cabinet may rest upon can be fitted with a waterproof, nonskid and/or elevated surface so as to prevent the cabinet from trapping water or moisture beneath the Cabinet commonly found in bar applications and from restricting the Cabinet from sliding forward or backward when a Drawer is either extended or retracted.

FIG. 2 is an aerial view of the Cabinet in accordance with one or more novel aspects of the present invention and for use in practicing the method of this invention;

FIG. 3 is an aerial view of the Drawer in accordance with one or more novel aspects of the present invention and for use in practicing the method of this invention;

FIG. 4. is a sectional view of the Drawer in accordance with on or more novel aspects of the present invention and for use in practicing the method of this invention;

FIG. 5 is a perspective view of an optional Liner which fits into the Drawer and a screw top or snap top lid that may be affixed to the Liner to further protect the Spice when not in use.

### DETAILED DESCRIPTION OF THE PRESENT INVENTION

Before explaining the present invention in detail it is to be understood that the invention is not limited in its application to the particular arrangements shown and description since the invention is capable of other embodiments. Also, the terminology used herein is for the purpose of description and not of limitation.

Referring first to FIG. 2, the novel device shown consists of three (3) predominant parts; the Cabinet encasement (1), the Drawers (2) and Base (3). The Stand provides for the Wetting Area (4) and sufficient footprint in the direction of the Drawer(s) opening so that the Base offers stability to the Cabinet when a Drawer is in use (extended, filled with Spice and/or Liner and drinkware is introduced and depressed into the Spice).

The Drawer (2) is contoured, shaped, vaulted and domed as shown in FIG. 3 and FIG. 4, which elevates the center point of the Drawer (8) and gradually descends (9) to the periphery of the container terminating at a level plane (10)

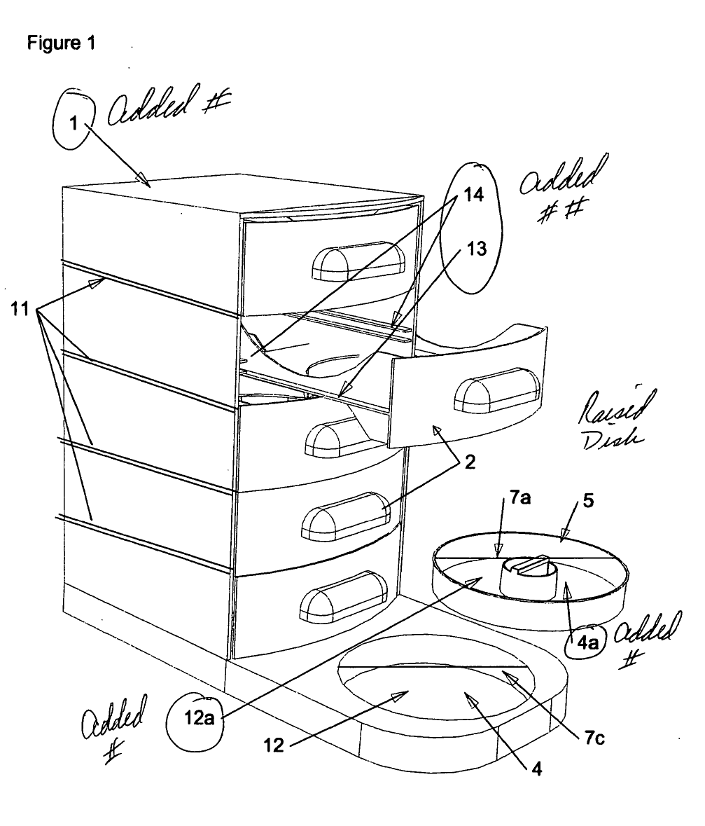

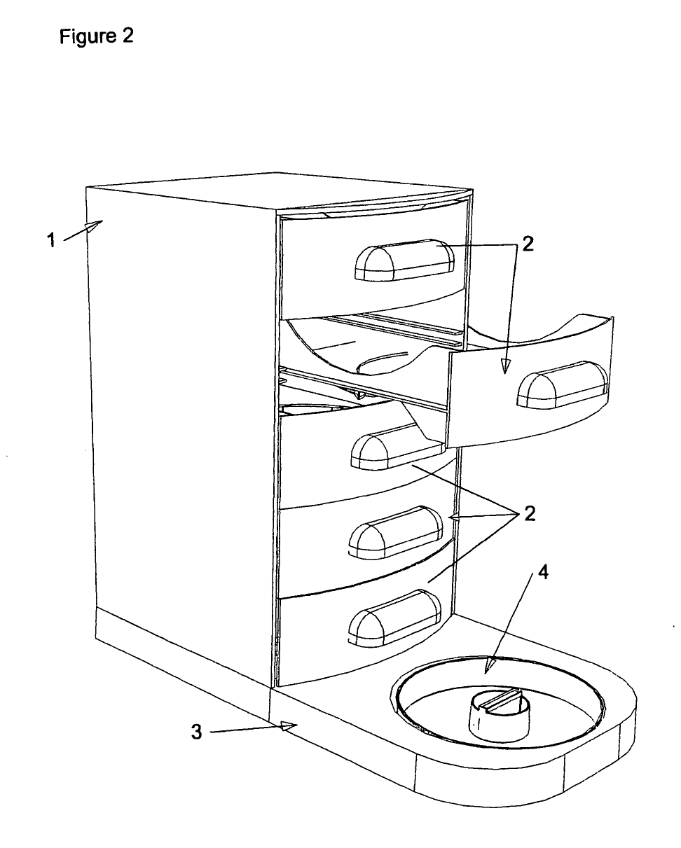

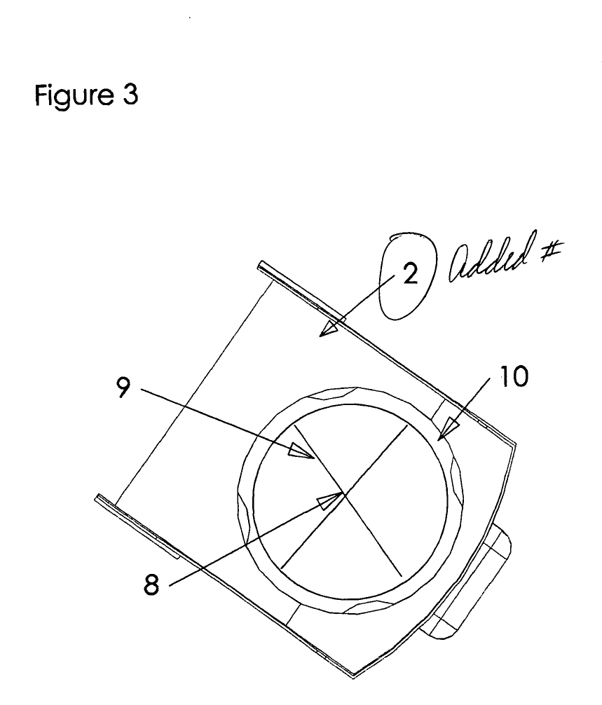

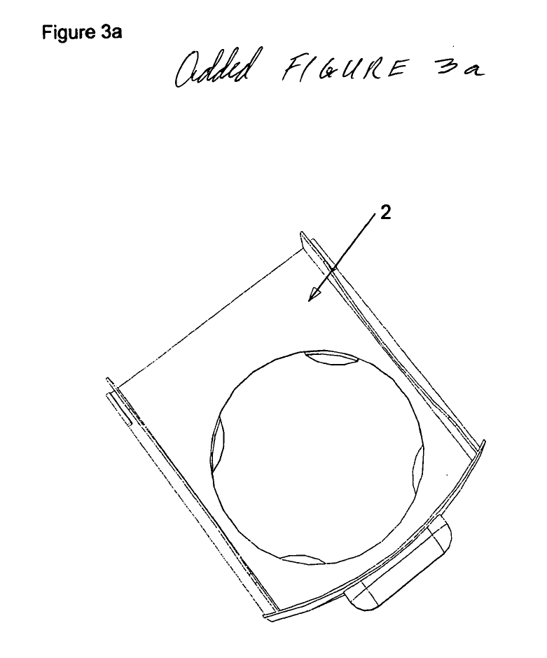

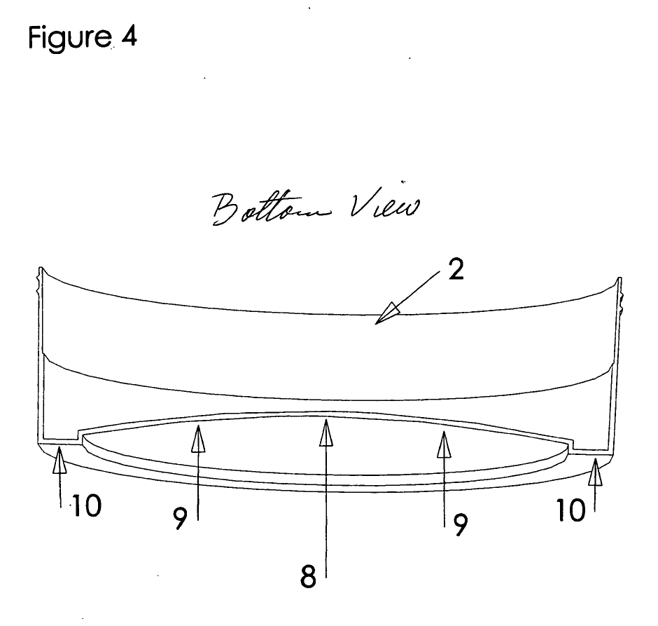

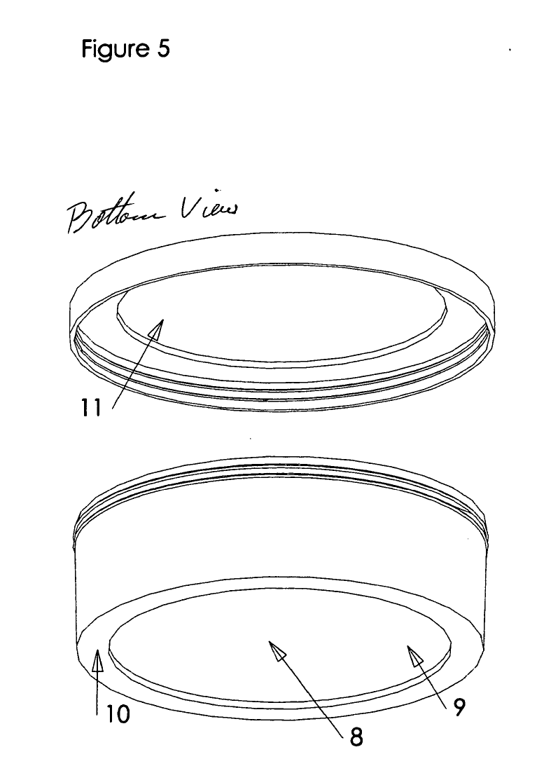

The Drawer contours are designed such that a fitted and matching (male) Liner, FIG. 5, may be inserted into the Drawer (female) FIGS. 1 and 2, (2).

Shown in FIG. 1, are Separators (11) between Drawer compartments that segregate and distinguish one Spice housed in a Drawer, whether hollowed or not, and/or Liner from all other Spice compartments while the drawer is closed in the Cabinet encasement (1).

The Wetting Reservoir Area (4) shown in FIG. 1, accommodates directly the wetting agent or either a Rimming Dish and suspension material to suspend and apply a wetting agent. The Wetting Reservoir is contoured (female) to accommodate a (male) Rimming Dish (5). The diameters (7c and 7a of the Wetting Reservoir and Rimming Dish respectively) are sufficient to accommodate common and large diameter drinkware when inverted and its rim introduced into the wetting agent.

Suspension material area(s) (12) of the Wetting Reservoir (4) and similarly of the Rimming Dish (5) are of greater depth and height than that of the suspension material so as to reduce the potential for spilling or overflow of the wetting agent when applied to the suspension material and further when drinkware is introduced into the same.

The Wetting Reservoir Area (4) and Rimming Dish (5), including suspension material (12) and wetting agent, and the moisture from the wetting agent, either through direct contact or due to the wetting agents' evaporation, are separated in proximity to avoid wetting agent or Spice contamination while being integrated into the same device.

A sliding, rotating, folding or other door contraption (not shown) may cover the Wetting Reservoir and/or Rimming Dish to protect and preserve the suspension material and wetting agent when not in use.

In FIG. 1, each Drawer (2) extends and slides open and contains either Spice filled directly in the Drawer or in a hollowed drawer (as shown) utilizing a Liner as shown in FIG. 5, that contains the Spice and that also matches the contours of the drawer with a center point (8), descents (9) and level planes (10). Each Drawer is equipped with rails/groves/guides (not shown) that guide the direction of the Drawer extension and retraction along with extension stops (not shown) to prevent the Drawer from overextension from the Cabinet encasement (1)

FIG. 5, shows a lid (11), either screw top or snap on, that can be used to secure and preserve Spice in the Liner while inside or outside of the Drawer, when not in use.

1-4. (canceled)

5. A substance-containing cabinet for use in applying the substance to rims of drink ware, the cabinet comprising:
a housing for receiving a plurality of drawers; and
first and second drawers movable at least partly linearly within the housing, wherein the first drawer is positioned within the housing above the second drawer when the second drawer is positioned at least partly within housing.

6. The cabinet of claim 5 further including a base adjacent to a bottom of the housing and supporting the bottom of the housing, wherein the base is positioned below the first drawer when the first drawer is within housing.

7. The cabinet of claim 6 wherein the first drawer has a first dimension in a first direction of the linear movement of the first drawer within the housing and wherein the base has a second dimension in the first direction greater than the first dimension.

8. The cabinet of claim 7 wherein the second dimension is approximately twice the first dimension.

9. The cabinet of claim 6 wherein the base includes a receptacle for supporting a wetting substance.

10. A substance-containing cabinet for use in applying the substance to rims of drink ware, the cabinet comprising:
a housing for receiving a plurality of drawers and having a lower portion;
a plurality of drawers, with at least one drawer movable within the housing; and
a base supporting the lower portion of the housing and having a portion extending away from the housing.

11. The cabinet of claim 10 wherein housing has a first width and the base has a second width and wherein the first and second widths are substantially the same.

12. The cabinet of claim 10 wherein the portion of the base extending away from housing is dimensioned sufficiently large to receive a receptacle for supporting a wetting substance.

13. The cabinet of claim 12 further including a receptacle for supporting a wetting substance wherein the receptacle is sized sufficiently large to receive at least a portion of the rim of an item of drink ware.

14. The cabinet of claim 10 wherein the base extends in a direction of movement of the drawer.

15. A method of applying a substance to a rim of drink ware, the method comprising:
introducing at least a portion of the rim of an item of drink ware to a wetting substance supported in a receptacle containing the wetting substance; and
opening a drawer containing a substance from a cabinet so that the drawer is at least partially removed from the cabinet and inserting the rim into the substance.

16. The method of claim 15 wherein pulling a drawer includes pulling the drawer linearly.

17. The method of claim 16 wherein pulling the drawer includes pulling the drawer so that at least one of the drawer and the receptacle is at least partly above the other of the drawer and the receptacle containing the wetting substance.

18. The method of claim 15 further including pushing the drawer into the cabinet so that the substance in the drawer is not accessible and is compartmentalized within the dimensions of the drawer and cabinet encasement.

19. The method of claim 18 wherein pushing the drawer into the cabinet includes pushing the drawer into the cabinet between separators.

20. A substance-containing cabinet for use in applying the substance to rims of drink ware, the cabinet comprising:
first and second receptacle's each of which contain a substance;
a housing containing the first and second receptacles; and
a separator between the first and second receptacles.

21. The cabinet of claim 20 wherein the separator is positioned between the first and second receptacles when the first and second receptacles are entirely within the cabinet.

22. A substance-containing cabinet for use in applying the substance to rims of drink ware, cabinet comprising:
a housing for receiving first and second drawers; and
first and second drawers within the housing, wherein the contents of the first drawer can be removed relative to the housing with the contents of the second drawer still supported by the housing.

23. The cabinet of claim 22 wherein the first drawer is received in the housing on a guide.

24. The cabinet of claim 23 wherein housing includes a channel for receiving the track.

25. The cabinet of claim 22 wherein the first and second drawers can be removed separately.

26. The cabinet of claim 22 wherein the housing includes housing walls separate from the drawers.

27. A substance-containing cabinet for use in applying the substance to rims of drink ware, the cabinet comprising:
a housing for receiving a plurality of drawers;
first and second drawers movable within housing; and
a support for a receptacle wherein the support is connected to the housing but outside the housing.

28. The cabinet of claim 27 further including a base and wherein the support for the receptacle is in the base.

29. The cabinet of claim 27 wherein the first drawer is movable in a first direction away from the housing and wherein the base extends away from the housing in the first direction.

30. The cabinet of claim 29 wherein the base extends away from the housing a distance sufficiently large to accommodate receipt of at least a portion of an item of drink ware for applying a substance to at least a portion of a rim of the drink ware.

31. The cabinet of claim 27 further including a receptacle in the support and wherein the receptacle is accessible when the first and second drawers are fully within the housing.
